(19) United States
(12) Patent Application Publication
(10) Pub. No.: US 2005/0202314 A1
(43) Pub. Date: Sep. 15, 2005

(54) Manufacturing method of secondary battery and device thereof

(76) Inventors: Jing-Yih Cherng, Taipei (TW); Ming-Lung Chen, Pan-Chiao City (TW)

Correspondence Address: ROSENBERG KLEIN & LEE;MORTON J ROSENBERG ESQ, 3458 ELLICOTT CENTER DRIVE, SUITE 101, ELLICOTT CITY, MD, 21043, US

(21) Appl. No.: 10/647,322

(22) Filed: Aug. 26, 2003

(51) Int. Cl. H01M 2/18; H01M 6/10; H01M 10/04

(52) U.S. Cl. 429/130; 29/623.5; 429/94; 29/623.1

(57) ABSTRACT

A manufacturing method of secondary battery and the device thereof are proposed. In this method, conducting material is trimmed into positive and negative electrode plates. Positive and negative active materials are coated on the positive and negative electrode plates, respectively. The positive and negative electrode plates are alternately arranged on a strip-shaped separator in an appropriate order. The positive and negative electrode plates on the separator are folded and then stacked according to their arrangement order so that each of the positive and negative electrode plates can be separated by the separator, and opposed faces between the positive and negative electrode plates have the active material coated thereon. The manufacturing process can thus be simplified, and the size and specification can be quickly changed to accomplish convenience in expansion. Moreover, the yield can be enhanced to accomplish the optimum economic benefit of production.

### FIELD OF THE INVENTION

The present invention relates to a secondary battery and, more particularly, to a manufacturing method of secondary battery and the device thereof, which can accomplish simple and quick manufacturing, have diverse adjustment function of specification, and can enhance the yield of secondary battery.

### BACKGROUND OF THE INVENTION

In a broad sense, condensers include and secondary batteries and capacitors. As shown in FIG. 1, an existent lithium secondary battery using aluminum foil as the battery package material comprises positive electrode plates 91 and negative electrode plates 92 using metal foil as the basic material and two strip-shaped separators 93 and 94. The manufacturing method of this kind of battery is by winding the positive and negative electrode plates and the separators. However, deviation may easily arise during winding to cause bad positioning. Therefore, a delicate winding machine having tension control is required, hence being difficult to conform to economic and flexible manufacturing. Related techniques are disclosed in R.O.C. Pat. No. 84,104,586 and U.S. Pat. Nos. 6,294,102B1 and 6,235,066B1. There is also another manufacturing method, wherein positive and negative electrode plates are stacked. As shown in FIGS. 2 and 3, a lithium battery comprises two positive electrode plates 95 and 96 and a negative electrode plate 97. A separator 98 is provided between the positive and negative electrode plates 95, 96 and 97. They all are positioned and stacked and then adhered together by hot embossing. However, in this method of stacking and hot embossing three plates and two separators, because there are so many plates to be positioned, the problems of positioning and flash of the plate result in a very high probability of short circuit between the positive and negative electrode plates, hence affecting the yield of battery.

### SUMMARY OF THE INVENTION

The primary object of the present invention is to provide a manufacturing method of secondary battery and the device thereof, which can simplify the manufacturing of secondary batteries and capacitors, quickly respond to diverse specification for expansion and production, and can also greatly enhance the yield.

Another object of the present invention is to provide a manufacturing method of secondary battery and the device thereof, which can greatly simplify the manufacturing machine of secondary batteries and capacitors. A certain speed of the manufacturing process can be accomplished even with simple tools manually, hence accomplishing smoothness of the production line and flexible production.

The various objects and advantages of the present invention will be more readily understood from the following detailed description when read in conjunction with the appended drawings, in which:

### BRIEF DESCRIPTION OF THE DRAWINGS

FIG. 1 is a manufacturing diagram of a conventional lithium polymer battery;

FIG. 2 is a manufacturing diagram of another conventional lithium polymer battery;

FIG. 3 is a cross-sectional view along line A-A in FIG. 2;

FIG. 4 is a perspective view of a lithium polymer battery of the present invention;

FIG. 5 is a diagram of a first embodiment of the present invention;

FIG. 6 is a diagram of a second embodiment of the present invention;

FIGS. 7 to 12 are diagrams showing different arrangement ways of plates of the present invention;

FIG. 13 is a diagram of a third embodiment of the present invention;

FIG. 14 is a diagram showing the folding operation according to the third embodiment of the present invention; and

FIG. 15 is another diagram showing the folding operation according to the third embodiment of the present invention; and

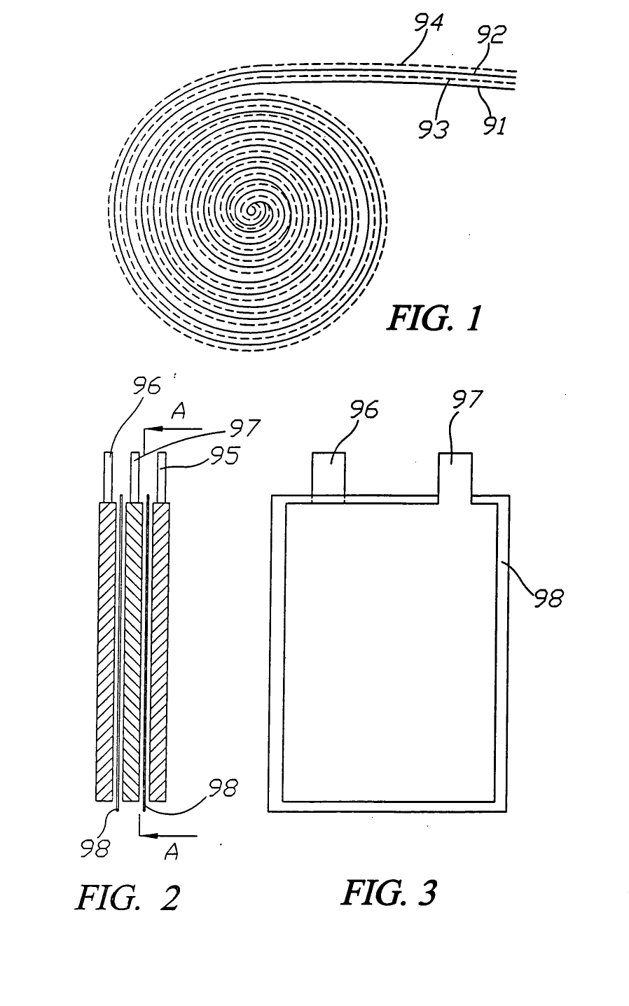

### DETAILED DESCRIPTION OF THE PREFERRED EMBODIMENTS

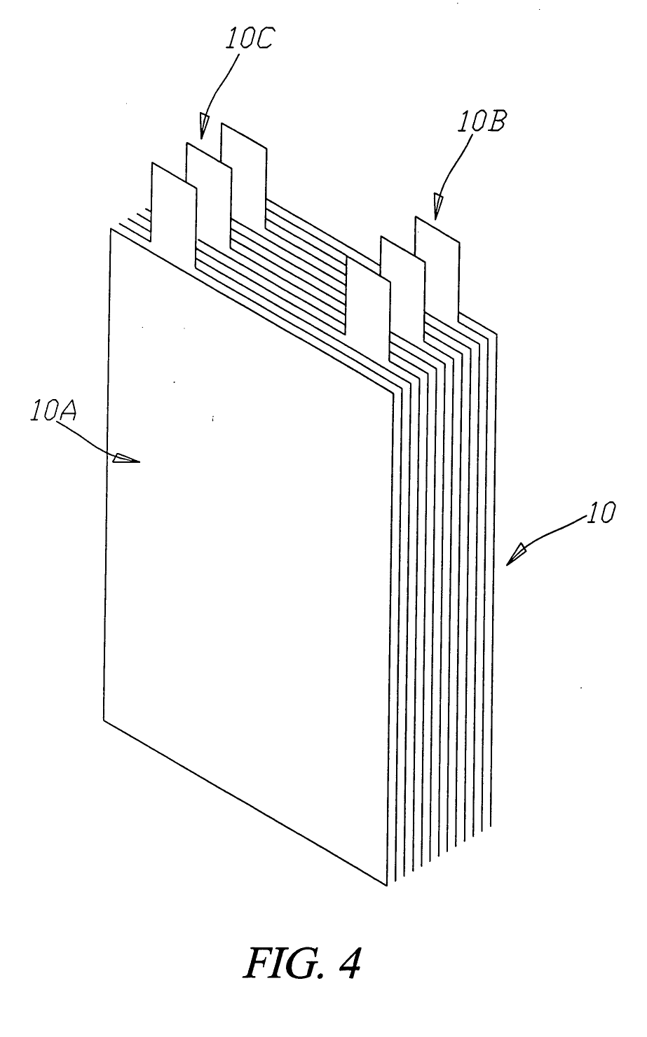

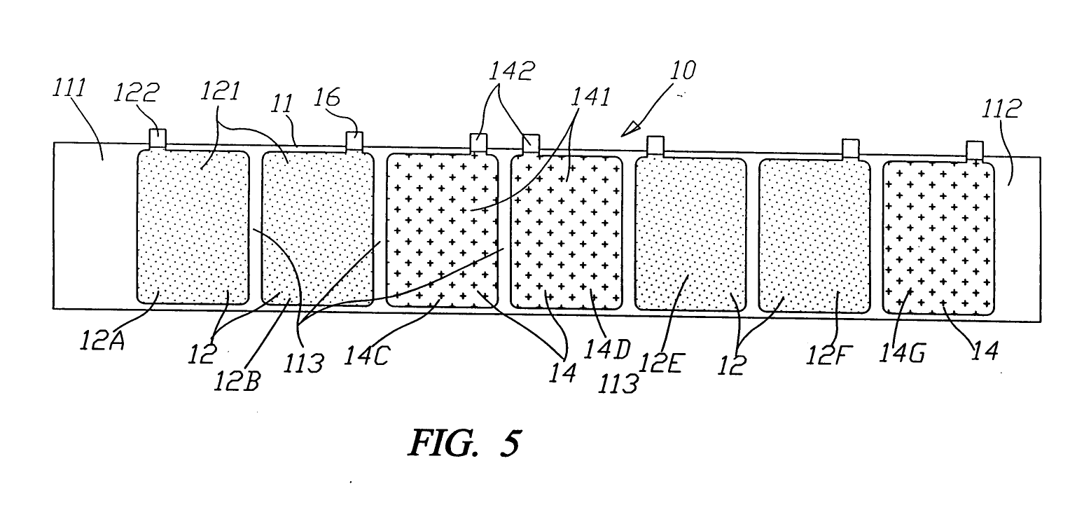

FIGS. 4 and 5 show a lithium polymer battery according to the first embodiment of the present invention. A lithium polymer battery (or a lithium-ion secondary battery) 10 is composed of a battery core 10A, positive electrode tabs 10B and negative electrode tabs 10C. The lithium polymer battery 10 comprises a separator 11 with a plurality of positive electrode plates 14 and negative electrode plates 12 adhered thereon. The material of the positive electrode plate 14 is aluminum foil (or other conducting material like metal net or carbon net). The positive electrode plate 14 includes a plate 141 and a projective conducting tab 142. The plate 141 is one-side or double-side coated with lithium-intercalation positive electrode active material (e.g., LiCoO₂, LiMn₂O₄, LiNi₂O₄). The conducting tab 142 is used for external electric connection for the plate 142, and is not coated with active material. The material of the negative electrode plate 12 is copper foil (or other conducting material like metal net or carbon net). The negative electrode plate 12 includes a plate 121 and a projective conducting tab 122. The plate 121 is one-side or double-side coated with lithium-intercalation negative electrode active material (e.g., graphite, coke, SnO₂ or other mixture). The conducting tab 122 is used for external electric connection for the plate 1242, and is not coated with active material. The lithium-intercalation positive and negative electrode active materials coated on the plates 141 and 121 are mainly used for incoming and outgoing, storage and release of lithium atoms. Besides, the plate 141 of the positive electrode plate 14 can be designed to have smaller length and width than the plate 121 of the negative electrode plate 12.

The lithium polymer battery 10 shown in FIGS. 4 and 5 is assembled using 7 sheets of the positive and negative electrode plates 14 and 12. The assembly method of the present invention is as follows:

1. Aluminum foil and copper foil are coated with active material and then trimmed into the positive and negative electrode plates 14 and 12.

2. The positive and negative electrode plates 14 and 12 are arranged in the order of two negative electrode plates 12, two positive electrode plates 14, two negative electrode plates 12 and a positive electrode plate 14. The positive and negative electrode plates 14 and 12 are adhered onto the separator 11. A front separator 111, a rear separator 112 and an intermediate separator 113 between the plates 121 and 141 are formed on the separator 11.

The positive and negative electrode plates 14 and 12 can be adhered on the separator by gluing to fix the positions of the plates 141 and 121 on the separator 11 to facilitate subsequent operations. Besides, a separator 11 thermally fusible at a certain temperature can be used to fully glue the plates 14 and 12 of the positive and negative electrode plates 14 and 12 thereon. After the battery core 10A is finished, hot embossing is proceeded to let the battery core 10A form a rigid shape having several layers of composite material and have the advantages of little expansion and stable electric characteristic. Moreover, the glue becomes porous or dissolves in the electrolyte after the solvent is evaporated.

Furthermore, the first and second negative electrode plates 12A and 12B are one-side coated with the coated faces adhered on the separator 11. This is because they are stacked at the central layer of the battery core 10A after folded. The third positive electrode plate 12C, the fourth positive electrode plate 12D and the fifth negative electrode plate 12E are double-side coated. The sixth negative electrode plate 12F and the seventh positive electrode plate 12G are one-side coated. This is because they are the uppermost layer and the lowermost layer of the battery core 10A after folded.

3. The negative electrode plates 12 and the positive electrode plates 14 on the separator 11 are folded according to their arrangement orders. That is, after the front separator 111 is folded behind the first negative electrode plate 12A, the second negative electrode plate 12B to the seventh positive electrode plate 12G and the rear separator 112 are folded in order. Therefore, the negative or positive electrode plate 12 or 14 and the separator 11 are stacked a layer when folding each time. This will let the positive and negative electrode plates form an interlaced stack through the separator 11. The folding and assembly operation of the lithium polymer battery 10 is thus finished.

The front separator 111 sheathes the left edge of the first negative electrode plate 12A to let the folded first negative electrode plate 12A be separated from the third positive electrode plate 14C through the front separator 111 to avoid short circuit. The intermediate separator 113 can let the electrode plates keep away from the bent region. Adhesive tape or adhesive can be pasted on the rear separator 112 to fix the battery core 10A after folding is finished.

In the present invention, the positive and negative electrode plates are adhered on a separator and then folded. The required thickness of the battery core 10A is used to determine the number of required positive and negative electrode plates to be stacked. The larger the number of the stacked positive and negative electrode plates, the thicker the formed battery core 10A.

The conducting tabs 122 and 142 projective from the top of the plates 121 and 141 are designed to let the stacked plates 121 and 141 of the same polarity be a the same side. The stacked conducting tabs 142 form the positive electrode tabs 10B. The stacked conducting tabs 122 form the negative electrode tabs 10C. The positive electrode tabs 10B and the negative electrode tabs 10C are then soldered to external conducting tabs (not shown).

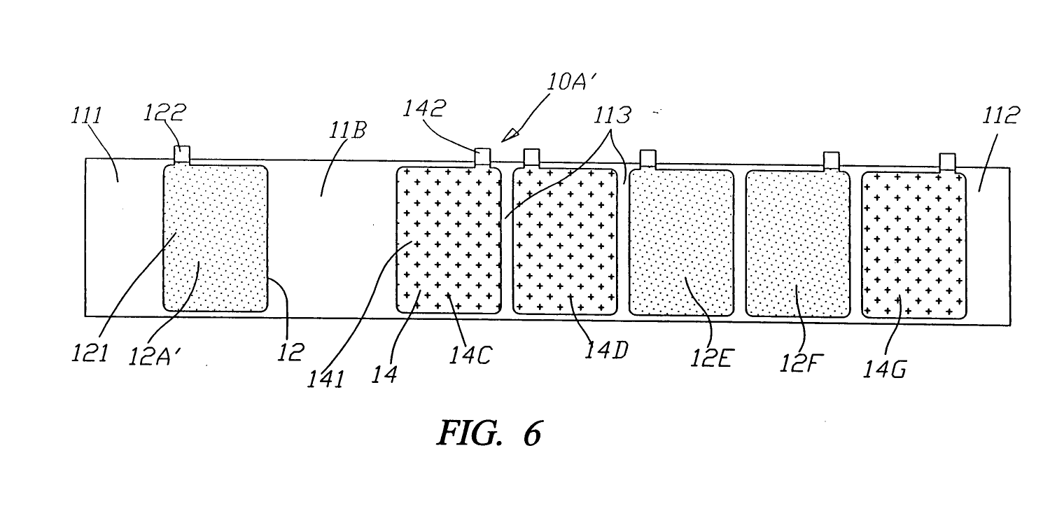

FIG. 6 shows a lithium polymer battery according to the second embodiment of the present invention. A first negative electrode plate 12A′ of a lithium polymer battery (or a lithium-ion secondary battery) 10′ is double-side coated to replace the second negative electrode plate 12B in FIG. 5 and form a second plate vacancy 11B, which lets the folded first negative electrode plate 12A′ be sheathed by the separator 11 double-sides to be separated from the third positive electrode plate 14C for avoiding short circuit. Therefore, the components of the lithium polymer battery 10′ are arranged in the order of the front separator 111, the first negative electrode plate 12A′, the second plate vacancy 11B, the third positive electrode plate 14C, the fourth positive electrode plate 14D, the fifth negative electrode plate 12E, the sixth negative electrode plate 12F, the seventh positive electrode plate 14G and the rear separator 112.

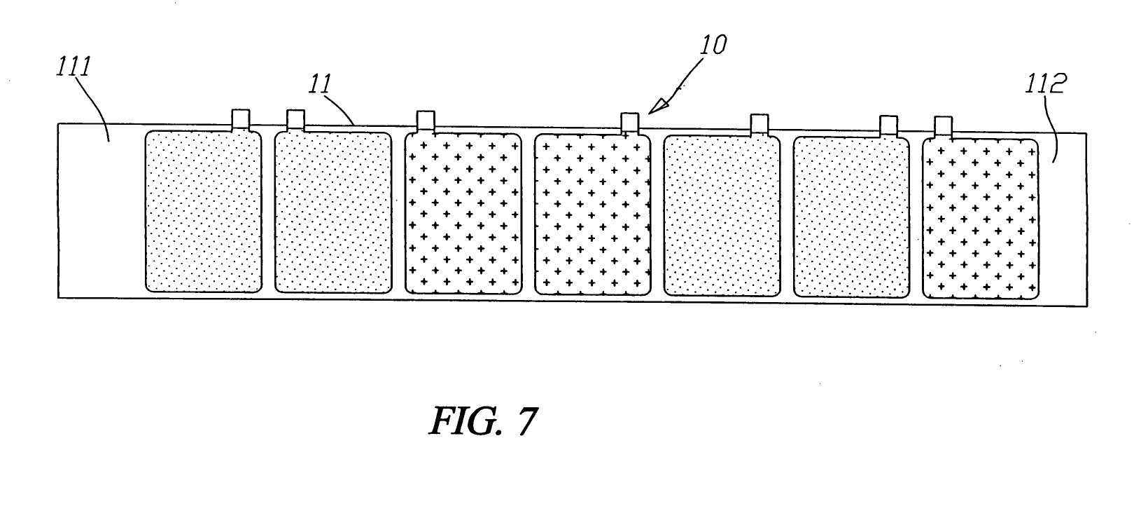

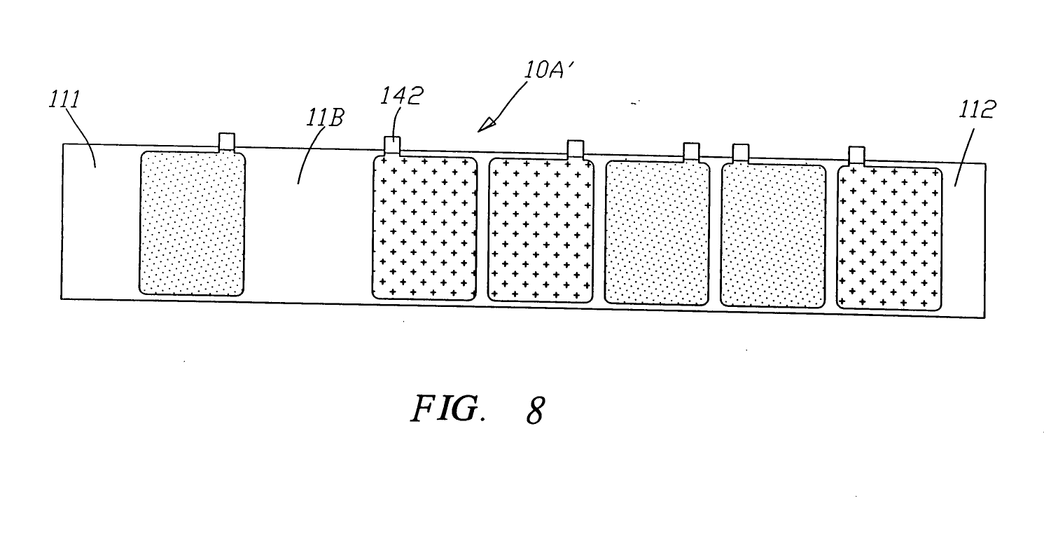

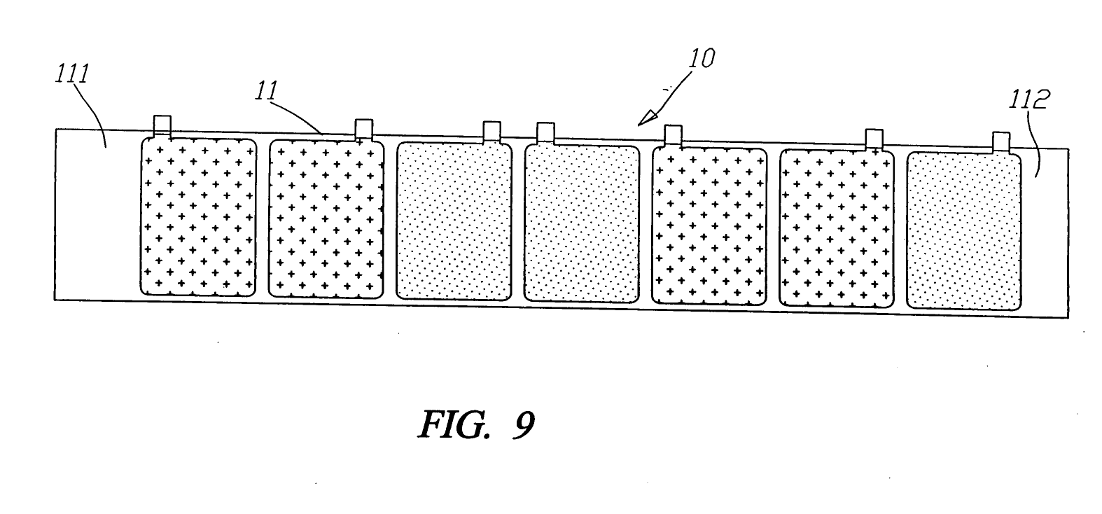

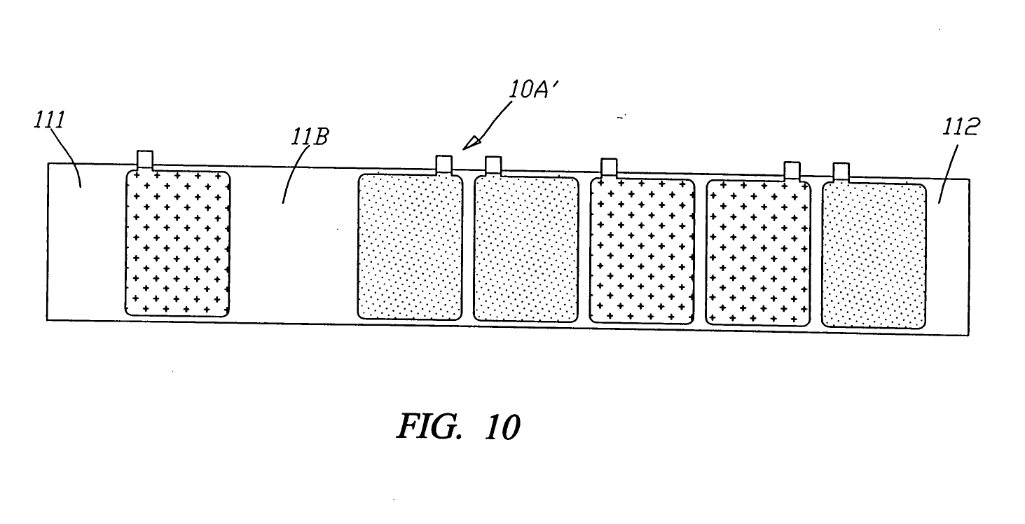

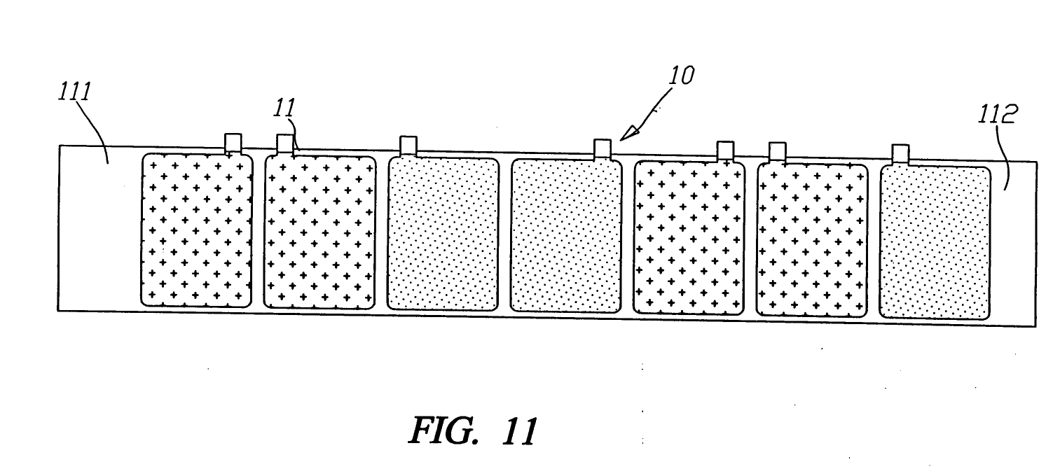

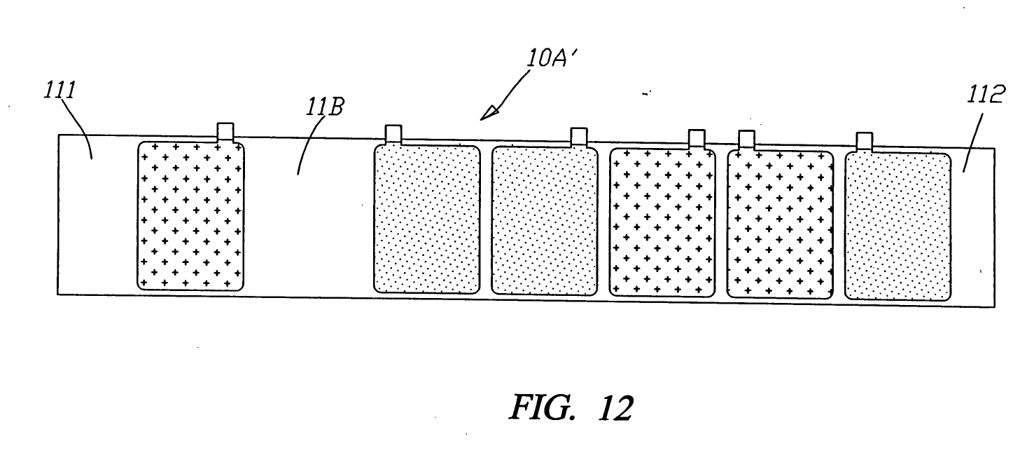

The arrangement order of the positive and negative electrode plates 14 and 12 of the above lithium polymer battery 10 and 10′ can be exchanged according to the polarity of plate. The first and second electrode plates can be two plates one-side coated or one plate double-side coated. The positions of the conducting tabs 142 and 122 of the positive and negative electrode plates 14 and 12 can also be simultaneously exchanged left and right. Therefore, there are eight ways of the arrangement shown in FIGS. 5 to 12. Besides, in the first embodiment, no matter what the first two electrode plates are two negative electrode plates 12 or two positive electrode plates 14, the last two electrode plates are designed to be electrode plates of different polarities. That is, the last two electrode plates are a negative electrode plate 12 and then a positive electrode plate 14 or a positive electrode plate 14 and then a negative electrode plate 12.

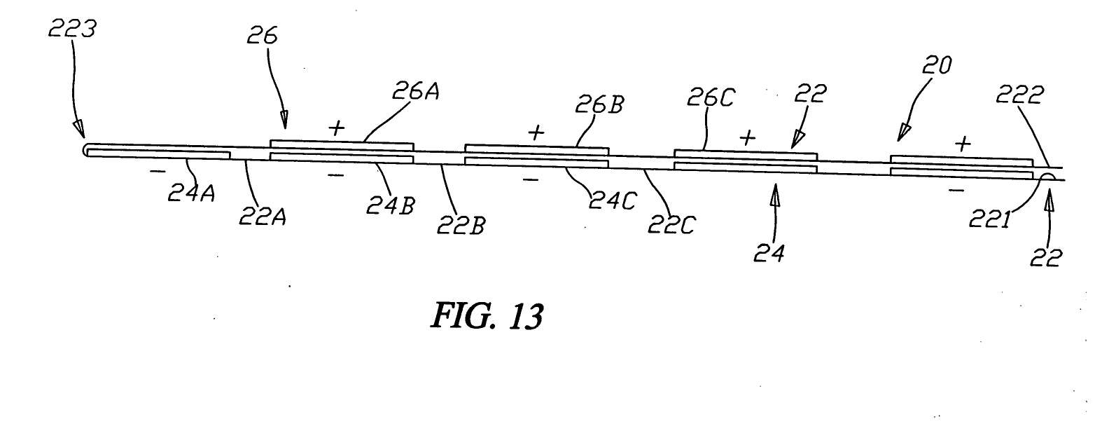

FIG. 13 is a diagram of the third embodiment of the present invention. A lithium polymer battery 20 is formed by arranging and folding a separator 22 a plurality of negative electrode plates 24 and positive electrode plates 26. The separator 22 is strip-shaped, and comprises a first face 221, a second face 222 and a bent end 223. A first negative electrode plate 24A, a second negative electrode plate 24B, a third negative electrode plate 24C, and so on are arranged on the first face 221 from the bent end 223 with increasing spacing (22A, 22B, 22C, and so on). A first positive electrode plate 26A, a second positive electrode plate 26B, a third positive electrode plate 26C, and so on are correspondingly arranged on the second face 222 from opposed to the second negative electrode plate 24B. In other words, the first positive electrode plate 26A corresponds to the second negative electrode plate, the second positive electrode plate 26B corresponds to the third negative electrode plate 24C and so on. The negative and positive electrode plates 24 and 26 can be adhered on the first face 221 and the second face 222 of the separator 22 through spot-gluing. Moreover, The continuous negative electrode plates on the first face 221 and the continuous positive electrode plates on the second face 222 can be exchanged. The bent end 223 can let the separator 22 be bent upwards or downwards. Therefore, the continuous negative electrode plates are at the first layer of the separator 22 and the continuous positive electrode plates are at the second layer of the separator 22, or the continuous positive electrode plates are at the first layer of the separator 22 and the continuous negative electrode plates are at the second layer of the separator 22.

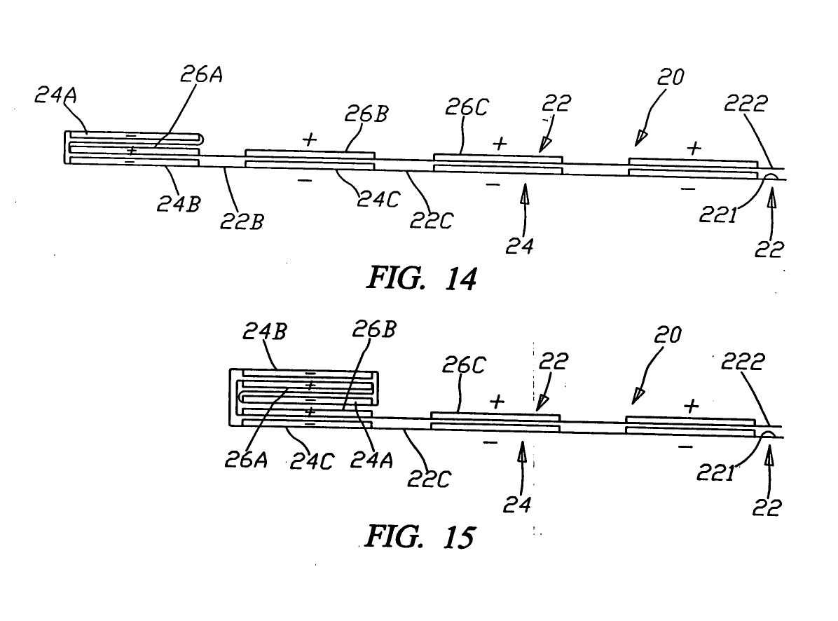

Please refer to FIGS. 14 and 15. When the lithium polymer battery 20 is to be folded and assembled, the first negative electrode plate 24A is first folded toward the first positive electrode plate 26A to form an initial stacking state of the first negative electrode plate 24A, the first positive electrode plate 26A and the second negative electrode plate 24B. Folding is then proceeded toward the second positive electrode plate 26B until the whole stacking and assembly is finished. Each pair of the positive and negative electrode plates 26 and 24 are separated by the separator 22. The increasing spacing (22A, 22B, 22C and so on) lets the electrode plates be able to go round the turning region and be flatly stacked at the previous layer. Besides, because the last two negative electrode plates are the uppermost and lowermost layers after folding, they can be one-side coated. That is, no matter what the first layer is a positive electrode plate or a negative electrode plate, the last two electrode plates of the first layer can be one-side coated. This way of arranging and folding the positive and negative electrode plates 26 and 24 on the separator 22 can greatly increase the manufacturing speed of the lithium polymer battery 20 and avoid confusion and pollution between the positive and negative electrode plates.

To sum up, the present invention not only provides a simplified manufacturing method, but also accomplishes quick change of size and specification and convenient expansion. A strip-shaped separator is used to fix positive and negative electrode plates so that folding can be proceeded along the edge of electrode plates. Even manual folding can achieve a good quality of the battery core. Moreover, the present invention eliminates the problem of tension control greatly enhance the yield, hence accomplishing the optimum economic benefit of production.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A manufacturing method of secondary battery comprising the steps of:
a. coating active material onto conducting material;
b. trimming said conducting material into positive plates and negative electrode plates;
c. alternately arranging said positive and negative electrode plates in proper order on a strip-shaped separator;
d. folding and stacking said positive and negative electrode plates on said separator according to their arrangement order to let said positive and negative electrode plates be separated by said separator and opposed faces between said positive and negative electrode plates have said active material coated thereon.

2. The manufacturing method of secondary battery as claimed in claim 1, wherein positive electrode active material is coated on one face of each of said positive electrode plates opposed to one of said negative electrode plates, and negative electrode active material is coated on one face of each of said negative electrode plates opposed to one of said positive electrode plates in said Step (d).

3. The manufacturing method of secondary battery as claimed in claim 1, wherein said positive and negative electrode plates are adhered on said separator, and a front separator, a rear separator and an intermediate separator between said positive and negative electrode plates are formed on said separator in said Step (d).

4. The manufacturing method of secondary battery as claimed in claim 1, wherein said positive and negative electrode plates are completely adhered on said separator, and said separator is thermally fusible and can be formed by hot embossing in said Step (d).

5. The manufacturing method of secondary battery as claimed in claim 1, wherein the first and second electrode plates in said Step (c) is of the same polarity, and said electrode plates of the same polarity are one-side coated with active material.

6. The manufacturing method of secondary battery as claimed in claim 1, wherein the last two electrode plates in said Step (c) are one-side coated with active material.

7. The manufacturing method of secondary battery as claimed in claim 1, wherein a conducting tab protrudes out of each of said positive and negative electrode plates, and said conducting tabs of the same polarity are at the same side after said positive and negative electrode plates are folded and stacked.

8. The manufacturing method of secondary battery as claimed in claim 1, wherein said electrode plates are alternately arranged in order with two positive electrode plates and then two negative electrode plates, and the last two electrode plates are electrode plates of different polarities.

9. The manufacturing method of secondary battery as claimed in claim 1, wherein said electrode plates are alternately arranged in order with two negative electrode plates and then two positive electrode plates, and the last two electrode plates are electrode plates of different polarities.

10. The manufacturing method of secondary battery as claimed in claim 8, wherein said first two positive electrode plates can be replaced with a positive electrode plate double-side coated with active material and a vacancy for connecting an electrode plate of the opposed polarity.

11. The manufacturing method of secondary battery as claimed in claim 9, wherein said first two negative electrode plates can be replaced with a negative electrode plate double-side coated with active material and a vacancy for connecting an electrode plate of the opposed polarity.

12. A secondary battery device comprising a battery core, positive electrode tabs and negative electrode tabs, said battery core comprising a plurality of positive and negative electrode plates separated by a separator, and said separator between said positive and negative electrode plates is a continuous strip-shaped separator.

13. The secondary battery device as claimed in claim 12, wherein positive electrode active material is coated on one face of each of said positive electrode plates opposed to one of said negative electrode plates, and negative electrode active material is coated on one face of each of said negative electrode plates opposed to one of said positive electrode plates.

14. The secondary battery device as claimed in claim 12, wherein the length and width of said positive electrode plate can be smaller than those of said negative electrode plate.

15. The secondary battery device as claimed in claim 12, wherein two side edges of said positive and negative electrode plates are sheathed by said strip-shaped separator to avoid short circuit between said positive and negative electrode plates.

16. The secondary battery device as claimed in claim 12, wherein said positive and negative electrode plates are adhered on said strip-shaped separator.

17. The secondary battery device as claimed in claim 12, wherein said separator is thermally fusible, is completely adhered with said positive and negative electrode plates, and is formed by hot embossing.

18. The secondary battery device as claimed in claim 12, wherein glue can be applied on said separator to fix said battery core.

19. A manufacturing method of a secondary battery, said secondary battery comprising a separator and a plurality of electrode plates, said separator being strip-shaped and comprising a first face, a second face and a bent end, said manufacturing method comprising the steps of:
arranging a plurality of said electrode plates of the same polarity on said first face in increasing spacing starting from said bent end;
arranging a plurality of said electrode plates of the opposed polarity on said second face starting from the second plate on said first face to let said separator have two layers of electrode plates of different polarities; and
folding in order the first electrode plate on said first face in the direction of the first electrode plate of the opposed polarity on said second face.

20. The manufacturing method of secondary battery as claimed in claim 19, wherein the last two of said continuously arranged electrode plates of the same polarity on the first layer can be one-side coated with active material.
